(19) United States
(12) Patent Application Publication
(10) Pub. No.: US 2014/0252265 A1
(43) Pub. Date: Sep. 11, 2014

(54) HEAT CONDUCTING THERMOPLASTIC MOULDING COMPOSITIONS COMPRISING A FLAME RETARDANT

(71) Applicant: BASF SE, Ludwigshafen (DE)

(72) Inventors: Claus Gabriel, Griesheim (DE); Yuichi Urano, Tokyo (JP); Alexander König, Bruchsal (DE); Kwee Heong Dennis Chern, Singapore (SG); Gaurav Ramanlal Kasaliwal, Mannheim (DE)

(73) Assignee: BASF SE, Ludwigshafen (DE)

(21) Appl. No.: 14/200,221

(22) Filed: Mar. 7, 2014

Related U.S. Application Data
(60) Provisional application No. 61/773,834, filed on Mar. 7, 2013.

(51) Int. Cl. C09K 5/14

(52) U.S. Cl. CPC C09K 5/14
USPC 252/75

(57) ABSTRACT

The present invention relates to a thermoplastic moulding composition, comprising at least one thermoplastic polymer A); at least one heat conducting filler B); and at least one halogen-containing flame retardant C). Moreover, the invention relates to the use of the inventive moulding compositions for production of fibers, films or mouldings, to the resultant mouldings and to the use thereof for heat transport.

The present invention is related to a moulding composition comprising at least one thermoplastic polymer, at least one heat conducting filler and at least one halogen-containing flame retardant. Moreover, the invention is related to the use of the inventive moulding compositions for production of fibers, films or mouldings, to the resultant mouldings of any type and to the use thereof for heat transport.

Thermal conductive materials play an important role in numerous areas of electronic and electrical applications including circuit boards in power electronics, electronics appliances, machinery and heat exchangers, i.e. in all fields where an overheating is to be avoided to prevent significantly reduced work efficiency and to realize a long service life. Nowadays, thermally conductive plastics become more and more common in parts of devices and appliances due to their light weight, low thermal expansion, ease of production and corrosion resistance. However, plastics tend to easily ignite when exposed to heat. For the use in electric and electronic applications, the plastic material must meet the requirements of the European and US standards such as the flame rating test UL 94. Accordingly, it has been customary to incorporate into plastic materials flame retardants.

The flame retardant known from the prior art are often unsatisfactory in terms of their performance properties when used in plastics. One major disadvantage is the frequently inadequate duration of the protective effect, owing to low migration stability or high vaporization tendency. In addition, the low migration stability or high vaporization stability affect the surface quality of the moulding compositions. Moreover, with respect to processing, many flame retardants are unstable under the plastic manufacturing conditions. Thus, the process of plastic manufacturing can become more complicated. Further disadvantages are the low compatibility with a wide range of plastics and the deterioration of the mechanical properties of the plastic material such as impact strength, tensile modulus, tensile strength or elongation at break. Many flame retardants may also degrade the electric properties and/or appearance of the plastic. A further disadvantage is that many flame retardants reduce the thermal conductivity of plastics containing heat conductive filler. Consequently, there continues to be a need for flame retardants and flame retardant compositions for use in plastics which exhibit improved performance properties while at the same time retaining good mechanical properties and surface quality,

EP-A 410 301 and EP-A 736 571 disclose by way of example polyesters and polyamides comprising halogen-containing flame retardant, antimony oxides mostly being used as synergists in these polymers. US 2007257240 teaches flowable thermoplastics with halogen flame retardancy system. WO 2010/028975 teaches thermoplastic moulding masses with increased flow capability containing at least one thermoplastic polyamide; at least one highly branched or hyper-branched polyether amine; and at least one thermally conductive filler. However, none of these references mentions the use of a halogen flame retardancy system in polymer compositions having a high thermal conductivity.

It is an object of the present invention to provide a thermoplastic moulding composition which has good mechanical properties and at the same time exhibits a flame-retardant effect. In particular, the thermoplastic moulding composition should pass UL 94 V-0 level at a thickness of 1 mm.

It has been found that specific halogen-containing flame retardants impart good flame retarding properties to heat conductive thermoplastic materials equipped therewith without deterioration of the thermal conductivity of the polymer.

Accordingly, the present invention relates to a thermoplastic moulding composition, comprising

(A) at least one thermoplastic polymer;

(B) at least one heat conducting filler; and

(C) at least one halogen-containing flame retardant.

Another aspect of the present invention relates to a fiber, a film, or a moulding of any type obtainable from the thermoplastic moulding composition as defined above.

Another aspect of the present invention relates to the use of the thermoplastic moulding composition as heat sink for dissipating heat in electric and electronic devices.

Another aspect of the present invention relates to the use of a combination of hexagonal boron nitride and wollastonite in a thermoplastic moulding composition as defined above for improving thermal conductivity and flame retardency.

In the terms of the present invention, flame retardants are understood to be substances which reduce the flammability of substrates which are equipped with them. They are active during the starting phase of a fire by enhancing the resistance of the flame-retarded material to decomposition by thermal stress and/or by preventing the spread of a source of ignition to the flame-retarded material, thus preventing, delaying or inhibiting the spread of a fire.

The term “plastics” is not synonymous with the term “polymer”, but refers to the product obtained from polymers or prepolymers after physical compounding and/or chemical hardening (curing) and optionally shaping.

“Compounding” is the mixing of polymers and additives.

Mixtures of polymers with other polymers are called polymer blends. Such blends may be composed of two or more thermoplastics (plastic blends). The blend may be homogeneous or heterogeneous.

As component A), the inventive thermoplastic moulding composition comprises at least one thermoplastic polymer. Thermoplastics are plastics which yield solid materials upon cooling of a polymer melt and soften upon heating, the shaping of a thermoplastic thus being a reversible process. They are normally composed of relatively high molar mass molecules. The thermoplastic polymer can be an amorphous, semi-crystalline or crystalline one.

Examples for suitable thermoplastic polymers are polyamides, polyolefins, polyester, polyoxymethylenes (POM), polycarbonates, vinylaromatic polymers, polyarylene ether sulfones, aromatic polyether such as poly(2,6-dimethyl-1,4-phenylenethe) and thermoplastic polyurethanes. The term “thermoplastic” is used both for the polymer per se as well as for the processed form.

According to a preferred embodiment, component A) is selected from the group consisting of vinylaromatic polymers, polyolefins, polyamides, polyesters, POM, polyarylene ether sulfone and mixtures thereof.

In a preferred embodiment, component A) comprises or consists of a vinylaromatic polymer. Vinylaromatic monomers used to prepare the vinylaromatic polymers include styrene, 4-methylstyrene (p-methylstyrene), α-methylstyrene, all isomers of vinyltoluene, ethylstyrene, butylstyrene, dimethylstyrene and mixtures thereof. In addition, the vinylaromatic monomers mentioned above can be copolymerized with other copolymerizable monomers. Examples of these monomers are (meth)acrylic acid, C₁-C₄ alkyl esters of (meth)acrylic acid, such as methyl acrylate, methyl methacrylate, ethyl acrylate, ethyl methacrylate, isopropyl acrylate, butyl acrylate, amides and nitriles of (meth)acrylic acid such as acrylamide, methacrylamide, acrylonitrile, methacrylonitrile, butadiene, ethylene, divinylbenzene, maleic anhydride, phenylmaleinimide and the like. Preferred copolymerizable monomers are acrylonitrile, butadiene, (meth)acrylic acid, (meth)acrylates, maleic anhydride and phenylmaleinimide, in particular acrylonitrile, butadiene, (meth)acrylic acid and (meth)acrylates. Specific examples for vinylaromatic polymers include polystyrene, poly(p-methylstyrene) and poly(a-methylstyrene).

Specific examples for vinylaromatic polymers also include copolymers of styrene or α-methylstyrene with dienes or acrylic derivatives, or graft copolymers of styrene or α-methylstyrene such styrene-acrylonitrile copolymers, α-methylstyrene-acrylonitrile copolymers, styrene-maleicanhydride copolymers, styrene-phenylmaleinimide copolymers, methylmethacrylate-copolymere, styene-methylmethacrylate-acrylonitrile-copolymers, styrene-acrylonitrile-maleic anhydride-copolymers, styrene-acrylonitrile-phenylmaleinimide-copolymers, α-methylstyrene-acrylonitrile-methyl methacrylate-copolymers, α-methylstyrene-acrylonitrile-t-butyl methacrylate-copolymers, styrene-acrylonitrile-t-butyl methacrylate-copolymers, preferably acrylonitrile styrene acrylate copolymers (ASA), acrylonitrile butadiene styrole copolymers (ABS) and styrene acrylonitrile copolymers (SAN). Also suitable are blends of styrene-based copolymers with polyamide (PA) or polycarbonate (PC) such as ABS/PA, ASA/PA, ASA/PC.

In a further preferred embodiment, component A) comprises or consists of a polyolefin. The polyolefin is preferably composed of repeat units which comprise ethylene and/or propylene. Preferably, the polyolefin is selected from the group of the polyethylenes, polypropylenes and copolypropylenes and mixtures of these. The copolypropylene is preferably composed of propylene and ethylene and also of up to 2% by weight of other alkenes, specially C₃-C₂₀ alkenes, such as 1-butene, 1-pentene, 1-hexene, methyl-1-butene, methyl-1-pentene, 1-octene, 1-decene, and mixtures of these.

In a further preferred embodiment, component A) comprises or consists of a polyamide. Polyamide polymers are herein to be understood as being homopolymers, copolymers, blends and grafts of synthetic long-chain polyamides having recurring amide groups in the polymer main chain as an essential constituent.

Examples of polyamide homopolymers are nylon-6 (PA 6, polycaprolactam), nylon-7 (PA 7, polyenantholactam or polyheptanoamide), nylon-9 (PA 9, 9-amino nonanoic acid), nylon-10 (PA 10, polydecanoamide), nylon-11 (PA 11, polyundecanolactam), nylon-12 (PA 12, polydodecanolactam), nylon-4,6 (PA 46, polytetramethyleneadipamide), nylon-6,6 (PA 66, polyhexamethyleneadipamide), nylon-6,9 (PA 69, polycondensation product of 1,6-hexamethylenediamine and azelaic acid), nylon-6,10 (PA 610, polycondensation product of 1,6-hexamethylene diamine and 1,10-decanedioic acid), nylon-6,12 (PA 612, polycondensation product of 1,6-hexamethylenediamine and 1,12-dodecanedioic acid), nylon 10,10 (PA 1010, polycondensation product of 1,10-decannethylenediamine and 1,10-decanedicarboxylic acid), PA 1012 (polycondensation product of 1,10-ecamethylenediamine and dodecanedicarboxylic acid) or PA 1212 (polycondensation product of 1,12-dodeca-methylenediamine and dodecanedicarboxylic acid).

Polyamide copolymers may comprise the polyamide building blocks in various ratios. Examples of polyamide copolymers are nylon 6/66 and nylon 66/6 (PA 6/66, PA 66/6, copolyamides made from PA 6 and PA 66 building blocks, i.e. made from caprolactam, hexamethylenediamine and adipic acid). PA 66/6 (90/10) may contain 90% of PA 66 and 10% of PA 6. Further examples are nylon 66/ 610 (PA 66/610, made from hexamethylenediamine, adipic acid and sebacic acid). Blends of the above-mentioned polyamides are also suitable and preferred, e.g. blends of PA 6 and PA 66 or blends of PA 66 and PA 610 or blends of PA 6 and PA 610 as well as blends of PA 6 and PA 66/6.

Polyamides further include partially aromatic (semiaromatic) polyamides. The partially aromatic polyamides are usually derived from aromatic dicarboxylic acids such as terephthalic acid or isophthalic acid and a linear or branched aliphatic diamine or an alicyclic diamine. In a specific embodiment, the partially aromatic polyamides comprise at least one copolymerized diamine selected from hexamethylenediamine, bis(4-aminocyclohexyl)methane (PACM), 3,3′-dimethyl-4,4′-diaminodicyclohexylmethane (MACM), isophoronediamine (IPDA) and mixtures thereof. In a more specific embodiment, the partially aromatic polyamides exclusively comprise hexamethylenediamine as the copolymerized diamine. In a further more specific embodiment, the partially aromatic polyamides exclusively comprise bis(4-aminocyclohexyl)methane as the copolymerized diamine. In a further more specific embodiment, the partially aromatic polyamides exclusively comprise 3,3′-dimethyl-4,4′-diaminocyclohexylmethane (MACM) as the copolymerized diamine. In a further more specific embodiment, the partially aromatic polyamides exclusively comprise isophoronediamine (IPDA) as the copolymerized diamine.

Examples are PA 9T (formed from terephthalic acid and 1,9-nonanediamine), PA 6T/6I (formed from hexamethylenediamine, terephthalic acid and isophthalic acid), PA 6T/6, PA 6T/6I/66 and PA 6T/66. Further examples are PA 8T, PA 12T, PA 6I/6T, PA 6/6T, PA 6I/6T/66, PA 6I/66, PA 6T/6I/PACM (formed from hexamethylenediamine, terephthalic acid, isophthalic acid and PACM), PA 12/MACMI (copolyamide based on PA12, MACM and and isophthalic acid), PA 12/MACMT (copolyamide based on PA12, MACM and terephthalic acid). Blends are also suitable and preferred, e.g. blends of PA 66 and PA 6I/6T, blends of PA 66 and PA 6T/6I, blends of PA 6 and PA 6T.

According to a specific embodiment, the polyamide is selected from PA 6, PA 66, PA 6I/6T, PA 6T/6I, PA 6T/6, PA 6/6T, PA 6T/66, PA 66/6T, PA 6T/6I/66, PA 6I/6T/66, PA 6I/66, and mixtures thereof.

Polyamides further include aromatic polyamides such as poly-meta-phenylene-isophathalamides (Nomex®) or poly-para-phenylene-terephthalamide (Kevlar®).

Polyamides can in principle be prepared by two methods. In a polymerization from dicarboxylic acids and diamines and also in a polymerization from amino acids or their derivatives, such as aminocarbonitriles, aminocarboxamides, aminocarboxylate esters or aminocarboxylate salts, the amino and carboxyl end groups of the starting monomers or starting oligomers react with one another to form an amide group and water. The water can subsequently be removed from the polymer. In a polymerization from carboxamides, the amino and amide end groups of the starting monomers or starting oligomers react with one another to form an amide group and ammonia. The ammonia can subsequently be removed from the polymer. This polymerization reaction is customarily known as a polycondensation.

A polymerization from lactams as starting monomers or starting oligomers is customarily known as a polyaddition.

Polyamides further include copolymers made of polyamides and of a further segment, for example taking the form of a diol, polyester, ether, etc., in particular in the form of polyesteramides, polyetheresteramides or polyetheramides. For example, in polyetheramides, the polyamide segment can be any commercial available polyamide, preferably PA 6 or PA 66 and the polyether is usually polyethylene glycol, polypropylene glycol or polytetramethylene glycol.

In a further preferred embodiment, component A) comprises or consists of a polyester, the polyester being preferably at least one linear polyester. Suitable polyesters and copolyesters are described in EP-A-0678376, EP-A-0 595 413, and U.S. Pat. No. 6,096,854, hereby incorporated by reference. Polyesters, as is known, are condensation products of one or more polyols and one or more polycarboxylic acids or the corresponding lactones. In linear polyesters, the polyol is a diol and the polycarboxylic acid a dicarboxylic acid. The diol component may be selected from ethylene glycol, 1,4-cyclohexanedimethanol, 1,2-propanediol, 1,3-propanediol, 1,4-butanediol, 2,2-dimethyl-1,3-propanediol, 1,6-hexanediol, 1,2-cyclohexanediol, 1,4-cyclohexanediol, 1,2-cyclohexanedimethanol, and 1,3-cyclohexanedimethanol. Also suitable are diols whose alkylene chain is interrupted one or more times by nonadjacent oxygen atoms. These include diethylene glycol, triethylene glycol, dipropylene glycol, tripropylene glycol, and the like. In general the diol comprises 2 to 18 carbon atoms, preferably 2 to 8 carbon atoms. Cycloaliphatic diols can be used in the form of their cis or trans isomers or as an isomer mixture. The acid component may be an aliphatic, alicyclic or aromatic dicarboxylic acid. The acid component of linear polyesters is generally selected from terephthalic acid, isophthalic acid, 1,4-cyclohexanedicarboxylic acid, 1,3-cyclohexanedicarboxylic acid, succinic acid, gtutaric acid, adipic acid, sebacic acid, 1,12-dodecanedioic acid, 2,6-naphthalenedicarboxylic acid, and mixtures thereof. It will be appreciated that the functional derivatives of the acid component can also be employed, such as esters, examples being the methyl esters, or anhydrides or halides, preferably chlorides. Preferred polyesters are polyalkylene terephthalates, and polyalkylene naphthalates, which are obtainable by condensing terephthalic acid or naphthalenedicarboxylic acid, respectively, with an aliphatic diol. For the purposes of the invention, the term “polyalkylene terephthalate” refers also to a polyalkylene terephthalate compound that can also comprise at least one acid differing from terephthalic acid. Said acid can derive from structures which have, in the main chain, an aromatic ring which derives from an aromatic dicarboxylic acid. The aromatic ring can be an unsubstituted or substituted ring. Suitable substituents are inter alia C₁- to C₄-alkyl groups such as methyl, ethyl, isopropyl, n-propyl- and n-butyl, isobutyl, and tert-butyl groups or fluorine.

Preferred polyalkylene terephthalates are polyethylene terephthalates (PET), which are obtained by condensing terephthalic acid with diethylene glycol. PET is also obtainable by transesterifying dimethyl terephthalate with ethylene glycol, with elimination of methanol, to form bis(2-hydroxyethyl)terephthalate, and subjecting the product to polycondensation, releasing ethylene glycol. Further preferred polyesters are poly-butylene terephthalates (PBT), which are obtainable by condensing terephthalic acid with 1,4-butanediol, polyalkylene naphthalates (PAN) such as polyethylene 2,6-naphthalates (PEN), poly-1,4-cyclohexanedimethylene terephthalates (PCT), and also copolyesters of polyethylene terephthalate with cyclohexanedimethanol (PDCT), copolyesters of polybutylene terephthalate with cyclohexanedimethanol. Also preferred are copolymers, transesterification products, and physical mixtures (blends) of the aforementioned polyalkylene terephthalates. Particularly suitable polymers are selected from polycondensates and copolycondensates of terephthalic acid, such as poly- or copolyethylene terephthalate (PET or CoPET or PETG), poly(ethylene 2,6-naphthalate)s (PEN) or PEN/PET copolymers and PEN/PET blends. Said copolymers and blends, depending on their preparation process, may also comprise fractions of transesterification products.

According to a more preferred embodiment, the thermoplastic polymer is selected from an aliphatic polyamide homopolymer, aliphatic polyamide copolymer, a partially aromatic polyamide and mixtures thereof. In particular, the thermoplastic polymer is a polyamide selected from PA 6, PA 7, PA 10, PA 11, PA 12, PA 66, PA 69, PA 610, PA 612, PA1010, PA 6/66, PA 66/6, PA 66/610 and mixtures thereof, preferably from PA 6, PA 11, PA 12, PA 66, PA 66/6 and PA 6/66. Particular preference is also given to blends of these polyamides or copolyamides.

According to a further more preferred embodiment, the thermoplastic polymer is a polyamide selected from PA 6, PA 66, PA 6T/66, PA 66/6T, PA 6T/6I, PA 6I/6T, PA 6/6T, PA 6T/6, PA 9T and PA 12T and mixtures thereof.

The amount of component A) is usually in the range from 19 to 79% by weight, preferably 25 to 70% by weight, more preferably 30 to 60% by weight, based on the total weight of the thermoplastic moulding composition.

As component B), the inventive thermoplastic moulding composition comprises at least one heat conducting filler. The at least one heat conducting filler is used to enhance the thermal conductivity of the thermoplastic moulding composition to achieve thermal conductivities of the thermoplastic moulding composition of at least 0.4 W/mK and preferably of at least 0.5 W/mK. According to a preferred embodiment, the through plane thermal conductivity is preferably at least 0.55 W/mK, more preferably at least 0.60 W/mK. The in plane thermal conductivity is preferably at least 1.5 W/mK, more preferably at least 1.8 W/mK.

Suitable heat-conducting fillers are graphite, carbon fiber, carbon nanotubes, carbon black, beryllium oxide, magnesium oxide, aluminium oxide, zinc oxide, zirconium oxide, aluminium nitride, hexagonal boron nitride, silicon carbide and boron carbide and mixtures thereof. Suitable heat-conducting fillers are also talcum, caolin or wollastonite. Wollastonite is a naturally-occurring industrial mineral whose main chemical composition consists of calcium, silicon, and oxygen. It is a calcium inosilicate mineral (CaSiO₃) that may contain small amounts of iron, magnesium, and manganese substituting for calcium. Wollastonite may also act as reinforcing agent. In a preferred embodiment, the heat-conducting filler is selected from beryllium oxide, magnesium oxide, aluminium oxide, zinc oxide, zirconium oxide, aluminium nitride, hexagonal boron nitride, silicon carbide and boron carbide, talcum, caolin, wollastonite and mixture thereof. More preferably, the heat-conducting filler is selected from aluminium nitride, hexagonal boron nitride, silicon carbide, wollastonite and beryllium oxide and mixtures thereof. Especially preferred is the use of a mixture of hexagonal boron nitride and wollastonite. According to a specific aspect of the present invention, the heat-conducting filler has a good thermal conduction and is at the same electrically insulating. In particular, component B) is hexagonal boron nitride. Likewise in particular, component B) is a mixture of hexagonal boron nitride and wollastonite.

The heat-conducting filler is usually in the form of particles. The heat-conducting filler usually has a particle size from 2 to 300 μm, preferably from 2 to 200 μm, from 3 to 100 μm and in particular from 5 to 50 μm. The median particle diameter d₅₀ is usually in the range from 2 to 100 μm and more preferably in the range from 5 to 50 μm.

According to a specific embodiment of the invention, the heat-conducting filler is finely pulverized. There are no particular surface area (BET) limitations for the heat-conducting filler used herein. For example, typical commercially available hexagonal boron nitride particles have a BET of less than 20 m²/g. According to a special embodiment of the present invention, hexagonal boron nitride has a BET in the range from 0.3 to 15 m²/g.

The loading of the thermoplastic moulding composition with the heat-conducting filler is usually in the range from 20 to 80% by weight, preferably 25 to 60% by weight and more preferably 30 to 55% by weight, based on the total weight of the thermoplastic moulding composition.

As component C), the thermoplastic moulding composition comprises at least one halogen-containing flame retardant. Mixtures of differing halogen-containing flame retardants can also be used as component C). The acting principle in the use of halogenated materials as flame retardants is the generation of halogen species (e.g. HX) which interfere in the gas phase with free radical organic “fuel” from the polymer substrate.

Example for suitable halogen-containing flame retardants are bromine or chlorine-containing flame retardants. Example for chlorine-containing flame retardants are chlorinated paraffins and dedecachloropentacyclooctadecadiene (declorane). More preferably, component C) is a brominated flame retardant. Suitable brominated flame retardants are for example brominated diphenyl ethers such as decabromo-diphenylether, brominated trimethylphenylindanes; tetrabromophthalic acid anhydride, tetrabromobisphenol A, hexabromocyclododecane, polypentabromobenzyl acrylates, oligomeric reaction products derived from tetrabromobisphenol A with epoxides and brominated polystyrene.

Examples for suitable brominated oligocarbonates are compounds of the formula (A), where n is <3

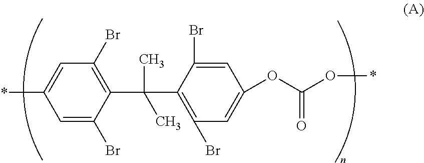

Flame retardants of this type are commercially available as BC 52 or BC 58 from Great Lakes.

Examples for suitable polypentabromobenzyl acrylates are those of the formula (B)

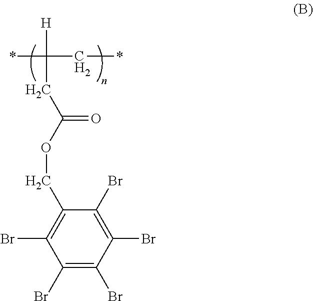

where n>4. Flame retardants of this type are commercially available as FR 1025 from Dead Sea Bromine (DSB).

Examples for oligomeric reaction products (n>3) derived from tetrabromobisphenol A with epoxides (e.g. FR 2300 and 2400 from DSB) are those of the formula (C)

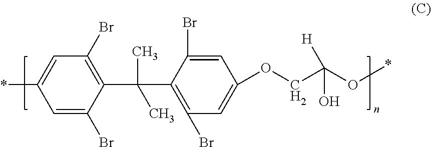

The brominated oligostyrenes preferably used as flame retardant have an average degree of polymerization (number-average) of from 3 to 90, preferably from 5 to 60, measured by vapor pressure osmometry in toluene. Cyclic oligomers are likewise suitable. In one preferred embodiment of the invention, the brominated oligomeric styrenes to be used have the following formula (D), where R is hydrogen or an aliphatic radical, in particular an alkyl radical, such as CH₂ or C₂H₅, and n is the number of repeat units in the chain. R′ can be either H or else bromine or else a fragment of a customary free-radical generator

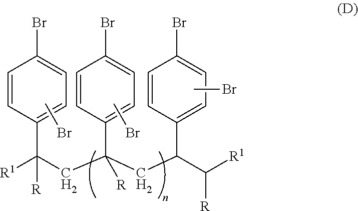

The value n can be from 1 to 88, preferably from 3 to 58. The brominated oligostyrenes comprise from 40 to 80% by weight of bromine, preferably from 55 to 70% by weight. Preference is given to a product which is composed mainly of polydibromostyrene. The substances can be melted without decomposition and, by way of example, are tetrahydrofuran-soluble. They may be prepared either via ring bromination of—where appropriate aliphatically hydrogenated—styrene oligomers, such as those obtainable via thermal polymerization of styrene (to DE-A 25 37 385) or via free-radical oligomerization of suitable brominated styrenes. The flame retardant may also be prepared via ionic oligomerization of styrene followed by bromination. The amount of brominated oligostyrene needed to render the polyamides flame retardant depends on the bromine content. The brominated polystyrene are usually obtained by a process described in EP-A 47 549.

A further suitable brominated oligostyrene is Saytex® 3010, available from Albemarle.

According to a preferred embodiment of the invention, component C) is a brominated polystyrene, in particular Saytex®3010.

It may be advantageous to combine the flame retardant C) with a flame retardant synergist D). Synergists are compounds which improve the effect of the proper flame retardant, often in an overadditive (synergistic) manner. Synergists which advantageously can be combined with the flame retardant C) include antimony trioxide, antimony pentoxide, sodium antimonate, and zinc borate. Preference is given to antimony trioxide and antimony pentoxide, in particular antimony trioxide. The flame retardant synergist can be added in neat form or in form of a masterbatch, for example in polyethylene.

The amount of halogen-containing flame retardant is dependent on the halogen content of the flame retardant. The total amount of component C) and component D), if present, is usually in the range from 1 to 30% by weight, preferably 5 to 25% by weight, more preferably 10 to 20% by weight, based on the total weight of the thermoplastic moulding composition.

The total amount of component C) and component D) is usually composed of 20 to 99% by weight, preferably from 50 to 85% by weight of the halogen-containing flame retardant C) and from 1 to 80% by weight, preferably from 15 to 50% by weight, of the flame retardant synergist D.

Surprisingly, it has been found that the halogen-containing flame retardant C) do not deteriorate the thermal conductivity of the thermoplastic moulding composition. In addition, in a flammability test, a V-0 level (1.0 mm, UL 94) can be achieved with a loading in the range of 1 to 30% by weight of halogen-containing flame retardant C) or in the range of 1 to 30% by weight of a combination of halogen-containing flame retardant C and flame retardant synergist D), based on the total weight of the thermoplastic moulding composition. In a specific embodiment, the thermoplastic moulding composition according to the present invention comprises 10 to 20% by weight of the halogen flame retardant C) and 2 to 6% by weight of the flame retardant synergist D), based on the total weight of the thermoplastic moulding composition, e.g. a loading of 15% by weight of halogen-containing flame retardant C and 4% of flame retardant synergist D).

The choice of suitable further additive depends in each case on the specific polymer to be compounded as well as on its end use and can be established by the skilled person.

The thermoplastic moulding composition according to the present invention may comprise further components as component E). Component E) comprises the usual additives for thermoplastic moulding compositions. Preferably, component E) is selected from antioxidants, heat stabilizers, UV-stabilizer, colorants, reinforcing materials, fillers, biocides, antistatic agents, rheology modifiers, plasticizer, impact modifiers, lubricants and mold release agents. It is also possible to use mixtures of said additives as component E).

Suitable antioxidants and heat stabilizers include sterically hindered phenols and/or phosphites, hydroquinones, aromatic secondary amines, such as diphenylamines, various substituted members of these groups, and mixtures of these in concentrations of up to 1% by weight, based on the total weight of the thermoplastic moulding compositions.

Suitable heat stabilizers which also stabilize the colour are, for example, sterically hindered phenolic antioxidants such as Irganox® 1098 (N,N′-hexane-1,6-diyIbis[3-(3,5-di-tert-butyl-4-hydroxyphenyl)propanamide, CAS: 23128-74-7), available from BASF SE; or Bruggolen TP-H7004 (copper, iodobis(triphenylphosphine)), available from Bruggemann Chemical.

Suitable UV stabilizers include various substituted resorcinols, salicylates, benzotriazoles, and benzophenones. They are generally used in amounts of up to 2% by weight, based on the total weight of the thermoplastic moulding composition.

The term colorants comprise dyes and pigments. Suitable pigments are inorganic and organic pigments. Examples for inorganic pigments are titanium dioxide, ultramarine blue, iron oxide, and carbon black. Examples for organic pigments are phthalocyanines, quinacridones and perylenes. Examples for dyes are nigrosine and anthraquinones.

Suitable fillers or reinforcing agents comprise, for example, glass fibers in the form of glass fabrics, glass mats or filament glass rovings, chopped glass, and glass beads. Glass fibers can be incorporated both in the form of short glass fibers and in the form of continuous fibers (rovings). In a specific embodiment, the thermoplastic moulding composition according to the present invention does not additionally comprise fillers or reinforcing agents when the component B) comprises or consists of wollastonite. In a further specific embodiment, the content of reinforcing agents added to the inventive thermoplastic moulding composition can be kept small, when the component B) comprises or consists of wollastonite.

Suitable biozides are a pesticide or an antimicrobial known in the art.

Suitable impact modifiers include acrylate-based ethylene terpolymers, polybutadiene, polyisoprene or copolymerisates of butadiene and/or isoprene with styrene, furthermore ethylene copolymers functionalized with maleic anhydride, ethylene-acrylic acid ionomers that are partially crosslinked with Zn²⁺, and thermoplastic elastomers made of flexible polyether and rigid polyimide. A preferred impact modifier is a random terpolymer of ethylene, methyl acrylate and glycidyl methacrylate, e.g. Lotader® AX 8900, available from Arkema.

Suitable plasticizers include dioctyl phthalate, dibenzyl phthalate, butyl benzyl phthalate, hydrocarbon oils and N-(n-butyl)benzenesulfonamide.

Suitable antistatic agents include amine derivatives such as N,N-bis(hydroxyalkyl)-alkylamines or -alkylenamines, polyethylene glycol esters and ethers, ethoxylated carboxylic esters and carboxamides, and glycerol monostearates and distearates, and also mixtures thereof.

The amounts usually used of other lubricants and mold-release agents are up to 1% by weight, based on the total weight of the thermoplastic moulding composition. Preference is given to long-chain fatty acids (e.g. stearic acid or behenic acid), salts of these (e.g. Ca stearate of Zn stearate), or montan waxes (mixtures composed of straight-chain, saturated carboxylic acids having chain lengths of from 28 to 32 carbon atoms), and also to Ca montanate or Na montanate, and also to low-molecular-weight polyethylene waxes and low-molecular-weight polypropylene waxes.

According to a preferred embodiment, an impact strength modifier is incorporated into the thermoplastic moulding composition to improve the strain at break and the impact toughness of the thermoplastic moulding composition. Here, it is also found that the appearance in terms of colour, i.e. whiteness, is significantly improved by the impact modifier.

If the thermoplastic moulding composition according to the present invention comprises the component E), the amounts used thereof can be from 0 to 50% by weight, based on the total mass of the thermoplastic moulding composition. In one preferred embodiment, the thermoplastic moulding composition comprises from 1 to 50% by weight, in particular from 1 to 45% by weight, of the component E), based on the total mass of the thermoplastic moulding composition.

According to a preferred embodiment, the thermoplastic moulding composition comprises as component A) a polyamide, as component B) a heat conducting filler selected from hexagonal boron nitride and wollastonite and mixtures thereof and as component C) a brominated polystyrene. According to a specific aspect of this embodiment, component A) is selected from PA 6, PA 11, PA 12, PA 66, PA 66/6 and PA 6/66 and mixtures thereof. According to a specific aspect of this embodiment, the thermoplastic moulding composition also comprises antimony trioxide as a flame retardant synergist D).

Even more preference is given to the thermoplastic moulding composition, in which component A) is PA 6 (Ultramid® B27 from BASF SE), component B) is hexagonal boron nitride, component C) is a brominated polystyrene (Saytex® 3010) and component D) is antimony trioxide.

Further even more preference is given to the thermoplastic moulding composition, in which component A) is PA 6 (Ultramid® B27 from BASF SE), component B) is hexagonal boron nitride and wollastonite, component C) is brominated polystyrene (Saytex® 3010) and component D) is antimony trioxide.

According to a further preferred embodiment, the thermoplastic moulding composition comprises as component A) a polyamide, as component B) a heat conducting filler selected from hexagonal boron nitride and wollastonite and mixtures thereof, as component C) a brominated polystyrene and at least one component E) comprising at least one impact modifier. According to a specific aspect of this embodiment, component A) is selected from PA 6, PA 11, PA 12, PA 66, PA 66/6 and PA 6/66 and mixtures thereof. According to a specific aspect of this embodiment, the thermoplastic moulding composition also comprises antimony trioxide as a flame retardant synergist D).

Even more preference is given to the thermoplastic moulding composition, in which component A) is PA6, component B) is hexagonal boron nitride, component C) is brominated polystyrene (Saytex® 3010), component D) is antimony trioxide and component E) comprises at least one impact modifier.

Further even more preference is given to the thermoplastic moulding composition, in which the component A) is PA 6 (Ultramid® B27 from BASF SE), component B) is hexagonal boron nitride and wollastonite, component C) is brominated polystyrene (Saytex® 3010), component D) is antimony trioxide and component E) comprises at least one impact modifier.

Equipping the at least one thermoplastic polymer A) with the components B) and C) and the optional further components D) and E) is carried out by known methods such as dry blending in the form of a powder, or wet mixing in the form of solutions, dispersions or suspensions. They may be added directly into the processing apparatus (e.g. extruders, internal mixers, etc.), e.g. as a dry mixture or powder or as solution or dispersion or suspension or melt.

The incorporation can be carried out in any heatable container equipped with a stirrer, e.g. in a closed apparatus such as a kneader, mixer or stirred vessel. The incorporation is for example carried out in an extruder or in a kneader. In general, it is immaterial whether processing takes place in an inert atmosphere or in the presence of oxygen.

The addition of the components B) and C) and the optional further components D) and E) to the polymer A) can be carried out in all customary mixing machines in which the polymer is melted and mixed with the components B), C), D), if present and E), if present. Suitable machines are known to those skilled in the art. They are predominantly mixers, kneaders and extruders, but also roll mills, roll mixers with heated rolls, and calenders.

The process is for instance carried out in an extruder by introducing components B), C) and further optional components during processing. Specific examples of suitable processing machines are single-screw extruders, contrarotating and corotating twin-screw extruders, multiscrew extruders, planetary-gear extruders, ring extruders or cokneaders.

Suitable extruders and kneaders are described, for example, in Handbuch der Kunststoffextrusion, Vol. 1 Grundlagen, Editors F. Hensen, W. Knappe, H. Potente, 1989, pp. 3-7, ISBN:3-446-14339-4 (Vol. 2 Extrusionsanlagen 1986, ISBN 3-446-14329-7).

If a plurality of components is added, these can be premixed or added individually.

The thermoplastic polymer component A) can be supplied in melted form, but generally in solid form, to the mixing apparatus used in accordance with the invention. If the polymer component is used in solid form then it may take the form of granules, powder, pellets or grindstock. In that case the polymer component is melted at temperatures of 150 to 300° C., for example.

The inventive thermoplastic moulding compositions feature good thermal conductivity together with good mechanical and flame retardancy properties. In particular, they meet UL 94V-0 level at a thickness of 1 mm.

The thermoplastic moulding composition according to the present invention can be processed by the processes normally used for the processing of thermoplastics, e.g., injection moulding and extrusion, into various molded articles.

These thermoplastic moulding compositions are suitable for the production of fibers, films, and mouldings of any type, in particular for applications in electric, electronic and optoelectronic devices such as wire sheatings, cable connections, electric enclosures, connectors, switches, housings, thermostat housings and heat sinks.

A preferred embodiment of the present invention refers to the use of the thermoplastic moulding composition as heat sink for dissipating heat in electric and electronic devices. In electronic systems, a heat sink is a component that cools a device by dissipating heat into the surrounding air. Heat sinks are used to cool electronic components such as semiconductor devices, and optoelectronic devices such as lasers and light emitting diodes (LEDs). According to a preferred embodiment, the thermoplastic moulding composition is used for dissipating heat from a semiconducting device. According to a specific aspect, the thermoplastic moulding composition is used for dissipating heat from LED devices. The heat is usually generated by a plurality of LEDs. The inventive thermoplastic moulding composition allows high heat dissipation.

The thermoplastic moulding compositions according to the invention show very good mechanical properties. They show excellent flame resistance properties and comply with the most stringent requirements of the UL 94 flame test. The thermoplastic moulding compositions of the invention comprising an impact modifier feature additionally an improvement in terms of color, i.e. it shows better ageing properties in that the thermoplastic moulding shows a reduced yellowness upon ageing.

The following examples are meant for illustrative purposes only and are not to be construed to limit the scope of this invention.

### EXAMPLES

The following materials were used in the experiments:

Component A): a commercially available PA 6 (Ultramid® B27 from BASF SE);

Component B1): hexagonal boron nitride, available from Dandong Chemical Engineering Institute Co., Ltd., China, specific surface 2.1 [m²/g], crystallite size: 27.5 μm, mean diameter d₅₀: 9.2 μm;

Component B2): hexagonal boron nitride, available from Dandong Chemical Engineering Institute Co., Ltd., China, specific surface 4.8 [m²/g], crystallite size: 31.5 μm, mean diameter d₅₀: 13.09 μm;

Component B3): hexagonal boron nitride, available from Dandong Chemical Engineering Institute Co., Ltd., China, specific surface 1.8 [m²/g], crystallite size: not determined, mean diameter d₅₀: 19.4 μm;

Component B4): Wollastonite Tremin 939 300 AST, Quarzwerke, Germany, specific surface 1.2 [m²/g], mean particle length I₅₀: 30 μm; mean aspect ratio 6/1; density 2.85 g/cm³, bulk density 0.4 g/cm³

Component C): brominated polystyrene Saytex® 3010, available from Albemarle;

Component D): flame retardant synergist Sb₂O₃ (90% in polyethylene);

Component E1): impact modifier Lotader® AX 8900 (random terpolymer of ethylene, methyl acrylate and glycidyl methacrylate), available from Arkema;

Component E2): impact modifier Fusabond® N NM493D, available from DuPont, ethylene-octene copolymer with maleic anhydride;

Component E3): antioxidant Irganox® 1098 (N,N′-hexane-1,6-diyIbis[3-(3,5-di-tert-butyl-4-hydroxyphenyl)propanamide], CAS 23128-74-7, available from BASF SE;

Component E4): color/heat stabilizer Bruggolen TP-H 70004 (copper, iodobis(triphenylphosphine)), available from Brüggemann Chemical;

Component E5): lubricant, Ca stearate

Component E6): colorant: titan dioxide, Kronos 2220, available from Kronos.

Preparation of the Mouldings Compositions

Components A) to E6) in the amounts specified in table 1 (the sum of the individual percentages by weight in the compositions C1 to C11 equal 100% by weight) were blended using a twin-screw extruder, at 260° and 400 rpm, with a throughput of 8 kg/h. The pellets were then used to produce extruded injection moulded specimens of dimensions 60*60*1.5 mm³ or specimens of dimensions 125*13 mm² for the UL 94 test with a thickness of 1 mm. The reference compositions C1, C2, C3 and C4 as well as the inventive compositions C5, C6, C7, C8, C9, C10 and C11 are compiled in table 1.

TABLE 1

| Component | | | | | | | | | | | |
|---|---|---|---|---|---|---|---|---|---|---|---|
| [% by weight] | C1 | C2 | C3 | C4 | C5 | C6 | C7 | C8 | C9 | C10 | C11 |
| A | 99.2 | 49.2 | 54.2 | 80.2 | 35.2 | 38.2 | 34.4 | 32.5 | 33 | 63.9 | 34.7 |
| B1^{#} | 0 | 49 | 44.8 | 0 | 45.1 | 0 | 0 | 0 | 0 | 0 | 0 |
| B2^{#} | 0 | 0 | 0 | 0 | 0 | 44 | 44 | 45.7 | 45.4 | 0 | 0 |
| B3^{#} | 0 | 0 | 0 | 0 | 0 | 0 | 0 | 0 | 0 | 16.1 | 12.8 |
| B4^{#} | 0 | 0 | 0 | 0 | 0 | 0 | 0 | 0 | 0 | 0 | 32.5 |
| C | 0 | 0 | 0 | 15 | 15 | 15 | 15 | 15 | 15 | 15 | 15 |
| D | 0 | 0 | 0 | 4 | 4 | 4 | 4 | 4 | 4 | 4 | 4 |
| E1 | 0 | 0 | 0 | 0 | 0 | | 3.5 | 3.5 | 3.5 | 0 | 0 |
| E2 | 0 | 0 | 0 | 0 | 0 | 0 | 0 | 0 | 0 | 0 | 0 |
| E3 | 0.3 | 0.3 | 0.3 | 0.3 | 0.3 | 0.3 | 0.5 | 0.5 | 0 | 0.5 | 0.5 |
| E4 | 0 | 0 | 0 | 0 | 0 | 0 | 0 | 0 | 0.5 | 0 | 0 |
| E5 | 0.5 | 0.5 | 0.5 | 0.5 | 0.5 | 0.5 | 0.5 | 0.5 | 0.5 | 0.5 | 0.5 |
| E6 | 0 | 0 | 0 | 0 | 0 | 0 | 0 | 4 | 4 | 0 | 0 |

^{#}solid content

Test Methods:

Flame retardancy: according to UL 94, 1 mm after conditioning for 2 days at room temperature (23° C.);

thermal conductivity: according to the flash method (ASTM E 1461-07) using a Netzsch LFA 447 Nanoflash® instrument;

tensile tests according to ISO 527-2:1993;

charpy impact strength unnotched according to ISO 179-2/1eU:1997;

colour measurements according to DIN 53236, method B (version January 1983), measurement geometry R45/0°, BYK Gardner instrument M00245

Flame retardant classification:
UL V-0: burning stops within 10 seconds on a vertical specimen, drips of particles allowed as long as they are not inflamed;
UL V-1: burning stops within 30 seconds on a vertical specimen; drips of particles allowed as long as they are not inflamed;
UL V-2: burning stops within 30 seconds on a vertical specimen; drips of flaming particles are allowed

The results of the tests are shown in table 2.

TABLE 2

| Property | C1 | C2 | C3 | C4 | C5 | C6 | C7 | C8 | C9 | C10 | C11 |
|---|---|---|---|---|---|---|---|---|---|---|---|
| through-plane thermal | 0.27 | 0.678 | 0.572 | 0.24 | 0.685 | 0.795 | 0.632 | 0.687 | 0.646 | 0.354 | 0.47 |
| conductivity [W/mK] | | | | | | | | | | | |
| in plane thermal | 0.27 | 4.86 | 3.388 | 0.26 | 3.9 | 5.176 | 4.127 | 4.445 | 4.869 | 1.11 | 1.93 |
| conductivity [W/mK] | | | | | | | | | | | |
| tensile modulus [MPa] | 2683 | 11574 | 10317 | 3189 | 11181 | 12348 | 6690 | 8979 | 12316 | 5206 | 13328 |
| stress at break [MPa] | 77 | 65.39 | 63.01 | 73.78 | 46.18 | 54.91 | 39.99 | 45.78 | 59.01 | 49.6 | 71.6 |
| strain at break [%] | 3.98 | 0.95 | 1.13 | 3.71 | 0.61 | 0.58 | 1.5 | 0.89 | 0.69 | 3.96 | 0.96 |
| impact strength | no break | — | — | 249 | 5.2 | 8.1 | 9.7 | 7.44 | 6.88 | — | 23.5 |
| a_{cu} [kJ/m²] | | | | | | | | | | | |
| V-grading UL 94 | V-2 | V- | V- | V-2 | V-0 | V-0 | V-0 | V-0 | V-0 | V-2 | V-0 |
| Whiteness L* after | — | 90.41 | | — | — | 92.06 | 92.76 | 94.47 | 94.01 | — | — |
| 0 h at 85° C. | | | | | | | | | | | |
| Whiteness L* after | — | 89.33 | — | — | — | 90.46 | 90.85 | 92.81 | 93.59 | — | — |
| 4000 h at 85° C. | | | | | | | | | | | |
| Yellowness b* after | — | 6.35 | — | — | — | 7.45 | 6.85 | 5.71 | 5.4 | — | — |
| 0 h at 85° C. | | | | | | | | | | | |
| Yellowness b* after | — | 10.2 | — | — | — | 11.48 | 9.94 | 8.52 | 7.39 | — | — |
| 4000 h at 85° C. | | | | | | | | | | | |
| percentage change b* | — | 60.6 | — | — | — | 54.1 | 45.1 | 49.2 | 36.9 | — | — |
| after 4000 h at 85° C. | | | | | | | | | | | |

As can be seen, composition C1 (neat PA 6) as well as composition C4 (polyamide composition comprising a flame retardant and a flame retardant synergist) meet a V-2 level, compositions C2 and C3 (polyamide composition comprising a heat conductive filler) did not yet meet V-2 level. In contrast thereto, the inventive compositions C5 to C9 and C11 even meet V-0 level though they comprise the same amount of flame retardant as C4. In addition, the thermal conductivity of the inventive compositions C5 to C9 and C11 is as high as that of the compositions C2 and C3. Composition C10 has a low amount of boron nitride as component B). The thermal conductivity is low, and flame retardancy is also low with level V-2. Combining boron nitride with wollastonite significantly enhances thermal conductivity (composition C11), and especially flame retardancy is at high level V-0.

Moreover, the inventive compositions show an improved colour appearance, i. e. higher degree of whiteness and less yellowness and an improved colour stability at 85° C.

1.-16. (canceled)

17. A thermoplastic moulding composition, comprising
(A) at least one thermoplastic polymer;
(B) at least one heat conducting filler; and
(C) at least one halogen-containing flame retardant.

18. The thermoplastic moulding composition according to claim 17, wherein component A) is selected from the group consisting of vinylaromatic polymers, polyolefins, polyamides, polyesters, polyoxymethylenes, polyarylene ether sulfones, and mixtures thereof.

19. The thermoplastic moulding composition according to claim 18, wherein the polyamides are selected from the group consisting of aliphatic polyamide homopolymers, aliphatic polyamide copolymers, partially aromatic polyamides and mixtures thereof.

20. The thermoplastic composition according to claim 17, wherein the polymer is a polyamide selected from the group consisting of PA 6, PA 7, PA 10, PA 11, PA 12, PA 66, PA 69, PA 610, PA 612, PA1010, PA 6/66, PA 66/6, PA 66/610, PA 6T/66, PA 66/6T, PA 6T/6I, PA 6I/6T, PA 6/6T, PA 6T/6, PA 9T, PA 12T and mixtures thereof, preferably from PA 6, PA 11, PA 12, PA 66, PA 66/6 and PA 6/66.

21. The thermoplastic composition according to claim 17, wherein the polymer is a polyamide selected from the group consisting of PA 6, PA 11, PA 12, PA 66, PA 66/6 and PA 6/66.

22. The thermoplastic moulding composition according to claim 17, wherein component B) is selected from the group consisting of beryllium oxide, magnesium oxide, aluminium oxide, zinc oxide, zirconium oxide, aluminium nitride, hexagonal boron nitride, silicon carbide and boron carbide, talcum, caolin, wollastonite and mixture thereof.

23. The thermoplastic moulding composition according to claim 17, wherein component B) is hexagonal boron nitride.

24. The thermoplastic moulding composition according to claim 17, wherein component C) is a brominated flame retardant selected from the group consisting of brominated diphenyl ethers, brominated oligocarbonates, brominated trimethylphenylindanes, tetrabromobisphenol A, tetrabromophthalic acid anhydride hexabromocyclododecane, polypentabromobenzyl acrylates, oligomeric reaction products derived from tetrabromobisphenol A with epoxides, brominated polystyrene, and combinations thereof.

25. The thermoplastic moulding composition according to claim 17, wherein component C) is a brominated polystyrene.

26. The thermoplastic moulding composition according to claim 17, comprising further a flame retardant synergist D), selected from the group consisting of antimony trioxide, antimony pentoxide, sodium antimonate, zinc borate, and combinations thereof.

27. The thermoplastic moulding composition according to claim 17, comprising at least one further component E), selected from the group consisting of antioxidants, heat stabilizers, UV-stabilizer, colorants, reinforcing materials, fillers, biocides, antistatic agents, rheology modifiers, plasticizer, impact modifiers, lubricants, mold release agents, and combinations thereof.

28. The thermoplastic moulding composition according to claim 17, wherein component A) is a polyamide selected from the group consisting of PA 6, PA 11, PA 12, PA 66, PA 66/6 and PA 6/66; component B) is hexagonal boron nitride component C) is a brominated polystyrene, and wherein optionally a flame retardant synergist D) is further contained.

29. The thermoplastic moulding composition according to claim 17, wherein component A) is a polyamide selected from the group consisting of PA 6, PA 11, PA 12, PA 66, PA 66/6 and PA 6/66; component B) is hexagonal boron nitride; component C) is a brominated polystyrene; optionally a flame retardant synergist D) is contained; and
optionally an impact modifier component E) is contained.

30. A fiber, a film, or a moulding comprising the thermoplastic moulding compositions according to claim 17.

31. The use of a thermoplastic moulding composition as defined in claim 17 as heat sink for dissipating heat in electric and electronic devices.

32. The use of a thermoplastic moulding composition according to claim 30 as heat sink for dissipating heat from a semiconducting device or as heat sink for dissipating heat from a light emitting diode (LED) device.

33. The use of a mixture of hexagonal boron nitride and wollastonite in a thermoplastic moulding composition as defined in claim 17 for improving the thermal conductivity and flame retardency.
